(19) United States
(12) Patent Application Publication
(10) Pub. No.: US 2026/0039428 A1
(43) Pub. Date: Feb. 5, 2026

(54) CROSSLINK INTERFERENCE MEASUREMENT FOR NON-TERRESTRIAL NETWORK SPECTRUM SHARING

(71) Applicant: QUALCOMM Incorporated, San Diego, CA (US)

(72) Inventors: Xiao Feng WANG, San Diego, CA (US); Alberto RICO ALVARINO, San Diego, CA (US); Peter GAAL, San Diego, CA (US); Vishnu Vardhan CHETLUR RAVI, San Diego, CA (US); Chiranjib SAHA, Lakeside, CA (US); Harikumar KRISHNAMURTHY, San Diego, CA (US)

(21) Appl. No.: 18/792,270

(22) Filed: Aug. 1, 2024

(51) Int. Cl. H04L 5/00; H04L 27/26

(52) U.S. Cl. CPC H04L 5/0048; H04L 27/2602

(57) ABSTRACT

Methods, systems, and devices for wireless communications are described. In some examples, a first UE may receive multiple instances of an SRS from a second UE via consecutive symbols. The second UE may apply a cyclic shift and may add a cyclic prefix to each instance of the SRS such that the second UE periodically transmits the SRS across the symbols. The first UE may monitor the symbols during an observation window to receive a portion of a first instance of the SRS and a portion of a second instance of the SRS. In some examples, the combination of the portion of the first instance of the SRS and the portion of the second instance of the SRS may comprise a full period of an instance of the SRS. Accordingly, the first UE may measure interference using the SRS and transmit a report indicating interference information.

### FIELD OF TECHNOLOGY

The following relates to wireless communications, including crosslink interference measurement for non-terrestrial network spectrum sharing.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving at least a first portion of a first instance of a sounding reference signal (SRS) in a first symbol, where the first symbol includes a first cyclic prefix and receiving at least a second portion of a second instance of the SRS in a second symbol that includes a second cyclic prefix and is consecutive to the first symbol in time, where the second instance of the SRS is based on a cyclic shift applied to the first instance of the SRS, the cyclic shift being based on a duration of the first cyclic prefix.

A UE for wireless communications is described. The UE may include one or more memories storing processor executable code, and one or more processors coupled with the one or more memories. The one or more processors may individually or collectively be operable to execute the code to cause the UE to receive at least a first portion of a first instance of an SRS in a first symbol, where the first symbol includes a first cyclic prefix and receive at least a second portion of a second instance of the SRS in a second symbol that includes a second cyclic prefix and is consecutive to the first symbol in time, where the second instance of the SRS is based on a cyclic shift applied to the first instance of the SRS, the cyclic shift being based on a duration of the first cyclic prefix.

Another UE for wireless communications is described. The UE may include means for receiving at least a first portion of a first instance of an SRS in a first symbol, where the first symbol includes a first cyclic prefix and means for receiving at least a second portion of a second instance of the SRS in a second symbol that includes a second cyclic prefix and is consecutive to the first symbol in time, where the second instance of the SRS is based on a cyclic shift applied to the first instance of the SRS, the cyclic shift being based on a duration of the first cyclic prefix.

A non-transitory computer-readable medium storing code for wireless communications is described. The code may include instructions executable by one or more processors to receive at least a first portion of a first instance of an SRS in a first symbol, where the first symbol includes a first cyclic prefix and receive at least a second portion of a second instance of the SRS in a second symbol that includes a second cyclic prefix and is consecutive to the first symbol in time, where the second instance of the SRS is based on a cyclic shift applied to the first instance of the SRS, the cyclic shift being based on a duration of the first cyclic prefix.

Some examples of the method, UEs, and non-transitory computer-readable medium described herein may further include operations, features, means, or instructions for measuring both the first portion of the first instance of the SRS and the second portion of the second instance of the SRS during a measurement window, where the measurement window spans at least a portion of the first symbol and at least a portion of the second symbol and transmitting a report indicating interference information associated with the SRS, where the interference information may be in accordance with the measuring.

Some examples of the method, UEs, and non-transitory computer-readable medium described herein may further include operations, features, means, or instructions for receiving configuration information associated with the SRS, where the configuration information indicates one or more of: a comb size associated with the SRS, a quantity of symbols associated with the SRS, or both, and where the configuration information may be in accordance with a subcarrier spacing (SCS) associated with the UE.

Some examples of the method, UEs, and non-transitory computer-readable medium described herein may further include operations, features, means, or instructions for receiving information associated with a second UE, the information including one or more of: a SCS associated with the second UE, a comb size associated with the second UE, a quantity of symbols associated with the SRS, or any combination thereof, where the comb size and the quantity of symbols may be in accordance with the SCS associated with the second UE.

Some examples of the method, UEs, and non-transitory computer-readable medium described herein may further include operations, features, means, or instructions for receiving configuration information associated with a resource set associated with the SRS, the configuration information indicating a frequency offset associated with the SRS, where the UE receives at least the first portion of the first instance of the SRS and receives at least the second portion of the second instance of the SRS in accordance with the frequency offset.

In some examples of the method, UEs, and non-transitory computer-readable medium described herein, the frequency offset indicates a quantity of subcarriers with respect to a physical resource block (PRB) boundary of the UE.

In some examples of the method, UEs, and non-transitory computer-readable medium described herein, the frequency offset indicates a difference between a first reference frequency associated with a first network entity and a second reference frequency associated with a second network entity.

In some examples of the method, UEs, and non-transitory computer-readable medium described herein, receiving at least the first portion of the first instance of the SRS and receiving at least the second portion of the second instance of the SRS may include operations, features, means, or instructions for receiving both the first portion of the first instance of the SRS and the second portion of the second instance of the SRS during a measurement window, where the measurement window may be expressed in symbols associated with the UE and may be based on one or more parameters Nₜ, SCS_{R}, SCS_{T}, or any combination thereof, where Nₜ may be a quantity of symbols associated with the SRS, where SCS_{R} may be a SCS associated with the UE, and where SCS_{T} may be a SCS associated with a second UE.

In some examples of the method, UEs, and non-transitory computer-readable medium described herein, the cyclic shift for a symbol sₖ may be defined by: sₖ₋₁((t+N_{cp}T_{c}) mod (T_{symbol}−N_{cp}T_{c})) for ranges of t between 0 and T_{symbol}−N_{cp}T_{c}, where sₖ₋₁ may be a preceding symbol, where sₖ₋₁(0) may be a first sample after the cyclic prefix of the preceding symbol sₖ₋₁ and sₖ(0) may be a first sample after the cyclic prefix of a symbol sₖ, where N_{cp} may be a quantity of samples of the first cyclic prefix, T_{c} may be a duration of a sample, and N_{cp}T_{c} may be a duration of the first cyclic prefix, and where T symbol may be a total time duration of the first symbol.

In some examples of the method, UEs, and non-transitory computer-readable medium described herein, a combination of the first portion of the first instance of the SRS and the second portion of the second instance of the SRS may comprise a full period of the SRS, the SRS having a duration of T_{symbol}−N_{cp}T_{c}; where T_{symbol} may be a total time duration of the first symbol, N_{cp} may be a quantity of samples of the first cyclic prefix, T_{c} may be a duration of a sample, and N_{cp}T_{c} may be a duration of the first cyclic prefix.

In some examples of the method, UEs, and non-transitory computer-readable medium described herein, the UE operates in a terrestrial network (TN) and may be in communication with a second UE that operates in a non-terrestrial network (NTN).

A method for wireless communications by a UE is described. The method may include transmitting a first instance of an SRS in a first symbol, where the first symbol includes a first cyclic prefix, applying a cyclic shift to the first instance of the SRS, where the cyclic shift is based on a duration of the first cyclic prefix, and transmitting a second instance of the SRS in a second symbol in accordance with the cyclic shift, where the second symbol includes a second cyclic prefix, and where the first symbol and the second symbol are consecutive in time.

A UE for wireless communications is described. The UE may include one or more memories storing processor executable code, and one or more processors coupled with the one or more memories. The one or more processors may individually or collectively be operable to execute the code to cause the UE to transmit a first instance of an SRS in a first symbol, where the first symbol includes a first cyclic prefix, apply a cyclic shift to the first instance of the SRS, where the cyclic shift is based on a duration of the first cyclic prefix, and transmit a second instance of the SRS in a second symbol in accordance with the cyclic shift, where the second symbol includes a second cyclic prefix, and where the first symbol and the second symbol are consecutive in time.

Another UE for wireless communications is described. The UE may include means for transmitting a first instance of an SRS in a first symbol, where the first symbol includes a first cyclic prefix, means for applying a cyclic shift to the first instance of the SRS, where the cyclic shift is based on a duration of the first cyclic prefix, and means for transmitting a second instance of the SRS in a second symbol in accordance with the cyclic shift, where the second symbol includes a second cyclic prefix, and where the first symbol and the second symbol are consecutive in time.

A non-transitory computer-readable medium storing code for wireless communications is described. The code may include instructions executable by one or more processors to transmit a first instance of an SRS in a first symbol, where the first symbol includes a first cyclic prefix, apply a cyclic shift to the first instance of the SRS, where the cyclic shift is based on a duration of the first cyclic prefix, and transmit a second instance of the SRS in a second symbol in accordance with the cyclic shift, where the second symbol includes a second cyclic prefix, and where the first symbol and the second symbol are consecutive in time.

Some examples of the method, UEs, and non-transitory computer-readable medium described herein may further include operations, features, means, or instructions for receiving configuration information associated with the SRS and transmitting the first instance of the SRS, the second instance of the SRS, or both, where the UE refrains from applying a frequency precompensation to the first instance of the SRS, the second instance of the SRS, or both in accordance with the configuration information.

In some examples of the method, UEs, and non-transitory computer-readable medium described herein, a symbol sₖ excluding the cyclic prefix may be defined by: sₖ₋₁((t+N_{cp}T_{c}) mod (T_{symbol}−N_{cp}T_{c})) for ranges of t between 0 and T_{symbol}−N_{cp}T_{c}, where sₖ₋₁ may be a preceding symbol, where sₖ₋₁(0) may be a first sample after the cyclic prefix of the preceding symbol sₖ₋₁ and sₖ(0) may be a first sample after the cyclic prefix of a symbol sₖ, where N_{cp} may be a quantity of samples of the first cyclic prefix, T_{c} may be a duration of a sample, and N_{cp}T_{c} may be a duration of the first cyclic prefix, and where T_{symbol} may be a total time duration of the first symbol.

In some examples of the method, UEs, and non-transitory computer-readable medium described herein, the UE operates in an NTN and may be in communication with a second UE that operates in a TN.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports crosslink interference (CLI) measurement for non-terrestrial network (NTN) spectrum sharing in accordance with one or more aspects of the present disclosure.

FIG. 2 shows an example of a wireless communications system that supports CLI measurement for NTN spectrum sharing in accordance with one or more aspects of the present disclosure.

FIG. 3 shows an example of a symbol pattern that supports CLI measurement for NTN spectrum sharing in accordance with one or more aspects of the present disclosure.

FIG. 4 shows an example of a process flow that supports CLI measurement for NTN spectrum sharing in accordance with one or more aspects of the present disclosure.

FIGS. 5 and 6 show block diagrams of devices that support CLI measurement for NTN spectrum sharing in accordance with one or more aspects of the present disclosure.

FIG. 7 shows a block diagram of a communications manager that supports CLI measurement for NTN spectrum sharing in accordance with one or more aspects of the present disclosure.

FIG. 8 shows a diagram of a system including a device that supports CLI measurement for NTN spectrum sharing in accordance with one or more aspects of the present disclosure.

FIGS. 9 and 10 show flowcharts illustrating methods that support CLI measurement for NTN spectrum sharing in accordance with one or more aspects of the present disclosure.

### DETAILED DESCRIPTION

In some wireless communications systems, devices associated with different radio access technologies (RATs) may share a spectrum (e.g., a frequency range). In some examples, a wireless communications system may include devices communicating in a terrestrial network (TN), devices communicating in a non-terrestrial network (NTN), or both. For example, a first UE may communicate with a network entity (e.g., a terrestrial network entity) via TN communications, and a second UE may communicate with an NTN node via NTN communications. In some cases, the NTN node may relay communications between the network entity and the second UE. In spectrum-sharing scenarios, devices communicating via the spectrum simultaneously may interfere with each other. For example, NTN communications from the second UE may interfere with TN communications from the first UE. In some examples, the second UE may transmit reference signaling, such as sounding reference signals (SRS), to allow the first UE to measure and report interference (e.g., crosslink interference (CLI)) caused by the second UE.

However, in some examples where the first UE is configured for TN communications and the second UE is configured for NTN communications, the first UE may be unable to receive SRS from the second UE due to differences between the TN and the NTN. For example, the NTN may be associated with longer propagation delays relative to the TN, which may prevent the first UE from synchronously receiving the SRS from the second UE. In some other examples, the TN and the NTN may each be associated with a different subcarrier spacing (SCS), a physical resource block (PRB) boundary, or both. Additionally, or alternatively, communications via the NTN may be frequency precompensated, but devices in the TN may be unaware of the frequency precompensation.

Various aspects of the present disclosure are related to CLI interference measurement for NTN spectrum sharing. In some examples, a receiving device (e.g., a first UE) may receive multiple instances of an SRS from a transmitting device (e.g., a second UE) via multiple consecutive symbols. The transmitting device may apply a cyclic shift and may add a cyclic prefix to each instance of the SRS following an initial instance of the SRS. By applying the cyclic shift, the transmitting device may transmit SRS in a periodic (e.g., repeating) manner. For example, the receiving device may monitor any portion of the multiple consecutive symbols for a duration equal to a duration of an SRS instance to receive an instance of the SRS or a cyclically shifted instance of the SRS. In some examples, the receiving device may monitor the multiple symbols during an observation window that spans a first portion of a first symbol and a second portion of a second symbol. The first portion of the first symbol may include a first portion of a first instance of the SRS, and the second portion of the second symbol may include a second portion of a second instance of the SRS. In such examples, the combination of the first portion of the first instance of the SRS and the second portion of the second instance of the SRS may comprise a full period of an instance of the SRS (e.g., one whole SRS). Accordingly, the receiving device may receive and measure interference using the SRS received via the first portion and the second portion and may transmit a report to a network entity indicating interference information.

Aspects of the disclosure are initially described in the context of wireless communications systems. Aspects of the disclosure are additionally illustrated by and described with reference to symbol patterns and process flows. Aspects of the disclosure are further illustrated by and described with reference to apparatus diagrams, system diagrams, and flowcharts that relate to CLI measurement for NTN spectrum sharing.

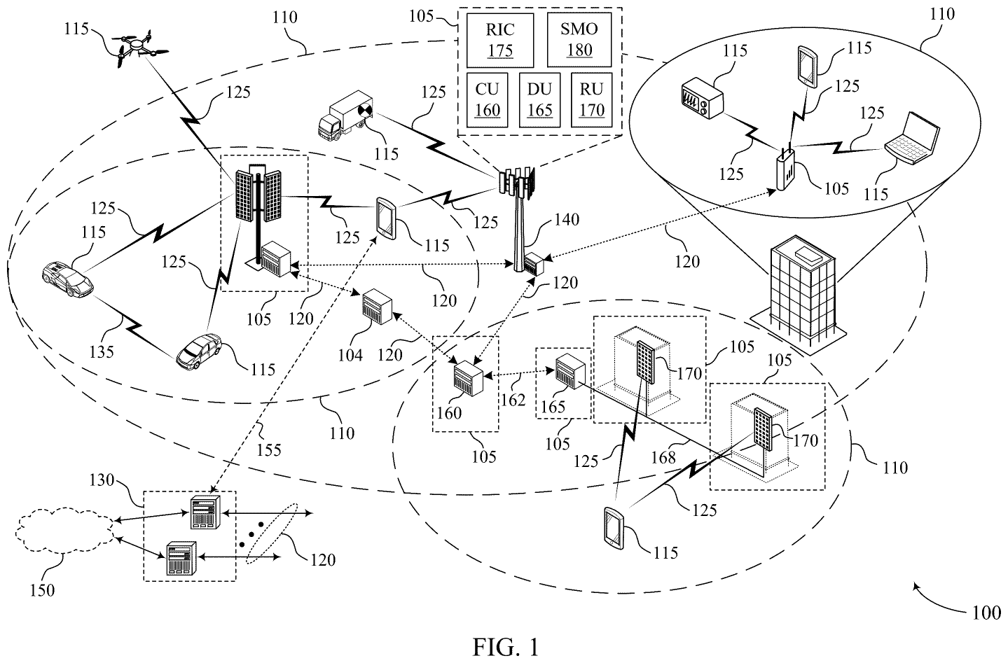

FIG. 1 shows an example of a wireless communications system 100 that supports CLI measurement for NTN spectrum sharing in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and SCS may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include an SCS (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported SCS, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on SCS. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., Nr) sampling periods. The duration of a symbol period may depend on the SCS or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IOT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be an example of an NTN and may support NTN communications. For example, the wireless communications system 100 may include base stations 140 that function as NTN nodes (e.g., non-terrestrial base stations). In some examples, an NTN node may communicate with base stations 140 (also referred to as gateways in NTNs) and UEs 115 (or other high altitude or terrestrial communications devices). An NTN node may be any suitable type of communication device configured to relay communications between different end nodes in a wireless communication system. In some cases, an NTN node may be an example of a satellite (e.g., a space satellite). In some cases, an NTN node may be an example of a high-altitude platform station (HAPS), a balloon, a dirigible, an airplane, a drone, an unmanned aerial vehicle, and the link. In some examples, an NTN node (e.g., a satellite) may operate as a bent pipe satellite that forwards (e.g., relays) communications between a UE 115 and a base station 140.

In some examples, an NTN node may be in a geosynchronous orbit (GSO), geostationary earth orbit (GEO), a high earth orbit, a medium earth orbit (MEO), a low earth orbit (LEO), or a highly elliptical orbit, among other types of orbit. In some cases, an NTN node may be a multi-beam satellite configured to provide service for multiple service beam coverage areas in a predefined geographical service area.

An NTN node may be any distance away from the surface of the earth. In some examples, NTN communications may refer to wireless communications between a UE 115 and an NTN node, and terrestrial network communications may refer to wireless communications between a UE 115 and a terrestrial communication device, such as another UE 115 or a base station 140 (e.g., a terrestrial base station 140). In some examples, NTN communications may be configured according to different protocol types (e.g., MTC, enhanced MTC (eMTC), NB-IOT, etc.) that provide access to a network (e.g., core network 130) for different types of devices via the NTN.

In some examples, a first UE 115 may receive an SRS for measuring CLI caused by a second UE 115 from the second UE 115. In such examples, the first UE 115 may receive multiple instances of the SRS via multiple consecutive symbols. The first UE 115 may receive configuration information for measuring the SRS, configuration information for resources for receiving the SRS, information associated with the transmitting device, or any combination thereof, from a network entity. Additionally, or alternatively, the second UE 115 may receive configuration information for transmitting the SRS from the network entity. The second UE 115 may apply a cyclic shift and may add a cyclic prefix to each instance of the SRS following an initial instance of the SRS. In some examples, the cyclic shift may be based on a duration of the cyclic prefix.

By applying the cyclic shift, the second UE 115 may transmit SRS in a periodic manner. For example, the first UE 115 may monitor any portion of the multiple consecutive symbols within a duration that is the same as (e.g., equal to) a duration of the SRS (e.g., an instance of the SRS) to receive either an instance of the SRS, or an instance of the SRS that has been cyclically shifted. In some examples, the first UE 115 may monitor the symbols during an observation window that spans a first portion of a first symbol and a second portion of a second symbol. The first portion of the first symbol may include a first portion of a first instance of the SRS, and the second portion of the second symbol may include a second portion of a second instance of the SRS. In such examples, the combination of the first portion of the first instance of the SRS and the second portion of the second instance of the SRS may comprise a full period of an instance of the SRS (e.g., one whole SRS). Accordingly, the first UE 115 may receive and measure interference using the SRS received via the first portion and the second portion and may transmit a report to a network entity indicating interference information.

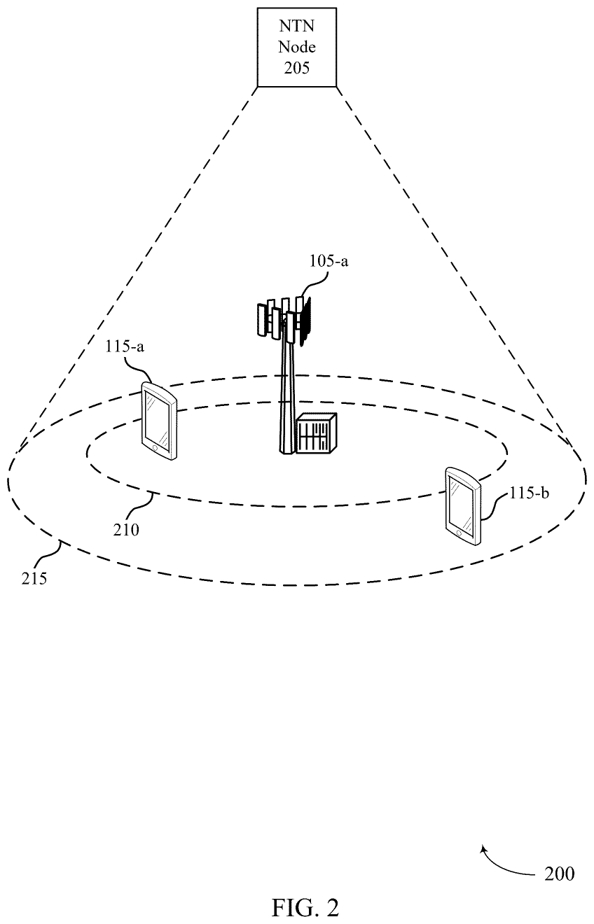

FIG. 2 shows an example of a wireless communications system 200 that supports CLI measurement for NTN spectrum sharing in accordance with one or more aspects of the present disclosure. The wireless communications system 200 may implement or be implemented by aspects of the wireless communications system 100 described with reference to FIG. 1. For example, the wireless communications system 200 may include a first UE 115-a, a second UE 115-b, a network entity 105-a, which may be examples of corresponding devices described herein, including with reference to FIG. 1. Additionally, the wireless communications system 200 may include an NTN node 205, which may be an example of an NTN node described with reference to FIG. 1. The wireless communications system 200 may support CLI measurement for NTN spectrum sharing to support improvements to interference measurement and coordination between devices in a spectrum-sharing communications system, among other benefits.

In some examples, the first UE 115-a may communicate with the network entity 105-a via a TN. For example, the network entity 105-a may be an example of a terrestrial base station 140 described with reference FIG. 1 and may support TN communications within a TN cell 210 (e.g., TN coverage area). The second UE 115-b may communicate with a second network entity 105 (not shown) via an NTN. For example, the second UE 115-b may communicate with the NTN node 205, which may relay communications between the second UE 115-b and the second network entity. In the example of FIG. 2, the network entity 105-a and the second network entity may be collocated. However, in some other examples, the network entity 105-a for TN and the second network entity for NTN may be separately located. The NTN node 205 may support NTN communications within an NTN cell 215 (e.g., an NTN coverage area). In some examples, the TN cell 210 and the NTN cell 215 may overlap (e.g., in space).

The wireless communications system 200 may implement spectrum sharing to support communications via multiple RATs within the wireless communications system 200. In some examples, the first UE 115-a may communicate using a first RAT (e.g., a TN), and the second UE 115-b may communicate using a second RAT (e.g., an NTN). In such examples, the wireless communications system 200 may support spectrum sharing between the TN and the NTN (e.g., TN-NTN spectrum sharing) such that the first UE 115-a and the second UE 115-b may simultaneously communicate with the network entity 105-a. In some cases, the wireless communications system 200 may implement reverse-link FDD spectrum sharing for both TN communications and NTN communications within an FDD spectrum (e.g., a TN FDD spectrum). In some other cases, the wireless communications system 200 may implement subband full duplex (SBFD) for TN communications within the TN FDD spectrum and FDD for NTN communications within the TN FDD spectrum.

In some examples where the wireless communications system 200 implements spectrum sharing, devices in the wireless communications system 200 may communicate reference signals for interference measurement. For example, uplink transmissions from the first UE 115-a may interfere with downlink communications to the second UE 115-b, downlink communications to the first UE 115-a may interfere with uplink transmissions from the second UE 115-b, or both. In such examples, the UEs 115 may communicate SRSs for measurement of potential CLI (e.g., downlink-to-uplink interference, uplink-to-downlink interference) to another UE 115. The UEs 115 may communicate the crosslink interference sounding reference signals (CLI-SRS) via one or more CLI-SRS resources.

TN communications (e.g., between the first UE 115-a and the network entity 105-a) may be associated with different communication parameters than NTN communications (e.g., between the second UE 115-b and the network entity 105-a). In some examples, an SCS for the TN cell 210 may be different than an SCS for the NTN cell 215. For example, the first UE 115-a and the second UE 115-b may receive signaling in accordance with a reference coordinate system associated with each RAT (e.g., the TN and the NTN, respectively). The reference coordinate system for a particular RAT may be based on the SCS associated with the RAT and may indicate physical resource block (PRB) information for the RAT, such as the SCS and a reference frequency (e.g., a PointA) for the RAT. The reference frequency may indicate a PRB boundary (e.g., a reference PRB) communicated via the RAT. Each UE 115 may communicate signaling in accordance with a PRB boundary for the RAT associated with each UE 115. For example, the first UE 115-a may communicate signaling in accordance with a first PRB boundary for the TN cell 210, and the second UE 115-b may communicate signaling in accordance with a second PRB boundary for the NTN cell 215. In some examples, the first PRB boundary and the second PRB boundary may be misaligned (e.g., may be different). That is, the first UE 115-a and the second UE 115-b may communicate signaling at different frequencies.

Additionally, or alternatively, NTN communications may be associated with communication delays relative to TN communications. For example, a total distance between both the second UE 115-b and the NTN node 205 and the NTN node 205 and the network entity 105-a may be further (e.g., longer) than a distance between the first UE 115-a and the network entity 105-a. Accordingly, NTN communications that are relayed to the NTN node 205 may include a significant (e.g., large) propagation delay relative to TN communications that are not relayed to the NTN node 205. Additionally, or alternatively, the propagation delay may vary (e.g., change) based on the locations of the second UE 115-b, the NTN node 205, or both.

In some cases, movement of the second UE 115-b, the NTN node 205, or both, may introduce a Doppler shift to signaling communicated via NTN (e.g., between the second UE 115-b and the network entity 105-a). In such cases, the second UE 115-b, the network entity 105-a, or both, may apply frequency pre-compensation to signaling communicated via NTN. That is, the second UE 115-b, the network entity 105-a, or both, may adjust the frequency of signaling communicated via NTN before the signaling is transmitted such that a receiving device receives the signaling within an expected frequency range.

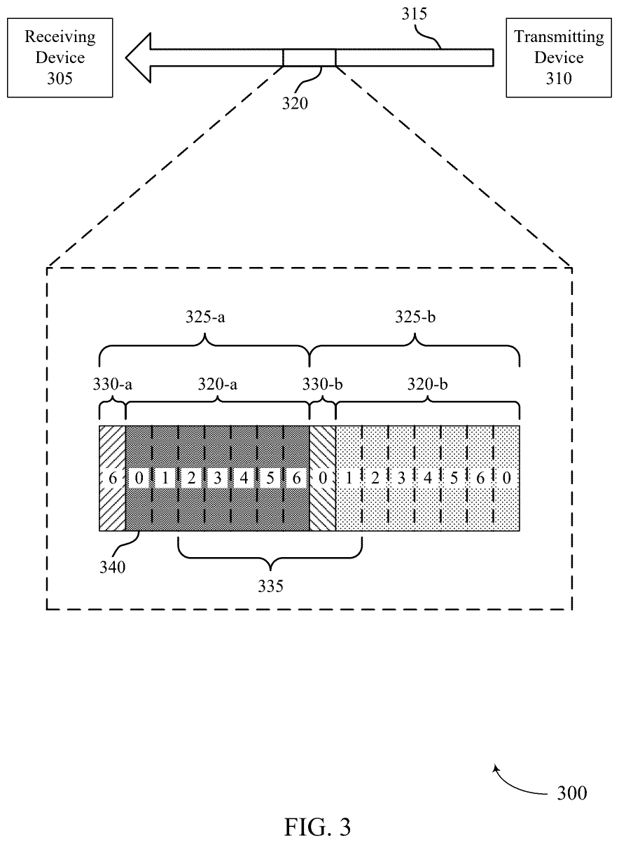

In the example of FIG. 2, the second UE 115-b may transmit CLI-SRS over uplink (e.g., UL SRS). The first UE 115-a may receive the CLI-SRS and measure associated CLI-SRS resources to estimate interference caused by the second UE 115-b. To account for NTN-specific parameters (e.g., propagation delay, SCS, frequency pre-compensation, PRB boundary), the first UE 115-a may asynchronously receive the CLI-SRS from the second UE 115-b. For example, the first UE 115-a may receive the CLI-SRS within a measurement window (e.g., observation window) defined by the first UE 115-a independent from when the second UE 115-b transmits the CLI-SRS. In some examples, the measurement window may span multiple symbols. For example, the second UE 115-b may transmit multiple instances of the CLI-SRS via multiple symbols. In some cases, the second UE 115-b may apply a cyclic shift and add a cyclic prefix to each instance of the CLI-SRS such that the CLI-SRS is transmitted across the multiple symbols in a periodic manner. By transmitting the CLI-SRS periodically, the first UE 115-a may receive an instance of the CLI-SRS or an instance of the CLI-SRS that has been cyclically shifted within any monitoring window of the same duration as an instance of the CLI-SRS, which may support asynchronous measurement of CLI-SRS by the first UE 115-a. Accordingly, the first UE 115-a may asynchronously measure the CLI and report the CLI to the network entity 105-a. Such examples are described in additional detail herein, including with reference to FIG. 3.

FIG. 3 shows an example of a symbol pattern 300 that supports CLI measurement for NTN spectrum sharing in accordance with one or more aspects of the present disclosure. In some examples, the symbol pattern 300 may implement or be implemented by aspects of the wireless communications system 100 and the wireless communications system 200 described with reference to FIGS. 1 and 2. For example, the symbol pattern 300 may be implemented by a receiving device 305 and a transmitting device 310. The receiving device 305 may be an example of a first UE 115-a and the transmitting device 310 may be an example of a second UE 115-b as described with reference to FIG. 2. The receiving device 305 and the transmitting device 310 may communicate via a communication link 315 (e.g., an uplink, a downlink, or both). In some examples, the receiving device 305 may implement TN communications, and the transmitting device 310 may implement NTN communications, to communicate with a network entity (not shown) as described with reference to FIGS. 1 and 2. In such examples, the receiving device 305 may asynchronously (e.g., in time) receive signaling from the transmitting device 310.

For example, the receiving device 305 may receive an SRS 320 from a transmitting device 310. In some examples, the receiving device 305 may receive multiple instances of the SRS 320 (e.g., the same SRS 320) from the transmitting device 310 in multiple symbols 325. For example, in FIG. 3, the receiving device 305 may receive a first instance of the SRS 320-a from the transmitting device 310 in a first symbol 325-a and may receive a second instance of the SRS 320-b from the transmitting device 310 in a second symbol 325-b. The second symbol 325-b may be consecutive to the first symbol 325-a in time. Though FIG. 3 shows an example where the SRS 320 is received via two symbols 325, there may be other examples (not shown) where the SRS 320 is received via any number of symbols 325. Each instance of the SRS 320 may be transmitted alongside a cyclic prefix 330. For example, the first symbol 325-a may include a first cyclic prefix 330-a before the first instance of the SRS 320-a, and the second symbol may include a second cyclic prefix 330-b before the second instance of the SRS 320-b.

In some examples, the receiving device 305 may measure the first instance of the SRS 320-a received during the first symbol 325-a and the second instance of the SRS 320-b received during the second symbol 325-b. For example, the receiving device 305 may monitor for and measure the SRS 320 during an observation window 335. In some examples, the receiving device 305 may reuse an existing fast Fourier transform (FFT) engine and maintain a same observation window 335 for asynchronously measuring the SRS 320 as an observation window 335 for receiving data from its connected network node (e.g., the network entity). In some examples, the observation window 335 may be the same as one or multiple FFT durations supported by the receiving device 305. The observation window 335 (e.g., expressed in the number of downlink symbols of the receiver) may be defined by Equation 1 below.

$${T}_{F F T} = {N}_{T} ( \frac{S C {S}_{R}}{S C {S}_{T}} ) + ( 0 or 2 ) \qquad ( 1 )$$

N_{T} may represent a quantity of symbols of the SRS 320, SCS_{R} may represent an SCS associated with the receiving device 305, and SCS_{T} may represent an SCS associated with the transmitting device 310. The network entity in communication with the receiving device 305 may expect the receiving device 305 to receive the SRS 320 within the observation window 335 if the receiving device 305 is performing asynchronous measurements on signaling (e.g., SRS 320) transmitted from the transmitting device 310. However, in some cases, the receiving device 305 may not receive an explicit indication of the observation window 335 from the network entity. Instead, the observation window 335 for measuring SRS 320 may be pre-defined (e.g., preconfigured) at the receiving device 305 based at least in part on the SRS transmit timing, N_{T}, SCS_{R}, and SCS_{T}.

In some examples, the observation window 335 may span multiple symbols 325. For example, in FIG. 2, the observation window 335 may span a portion of the first symbol 325-a and a portion of the second symbol 325-b. By measuring the SRS 320 during such an observation window 335, the receiving device 305 may receive the at least the portion of first instance of the SRS 320-a and the portion of the second instance of the SRS 320-b without a measurement gap (e.g., in time) in between the first symbol 325-a and the second symbol 325-b.

In such examples, the receiving device 305 may receive the second instance of the SRS 320-b in accordance with a cyclic shift. For example, the transmitting device 310 may apply a cyclic shift to each symbol 325 that follows a first SRS symbol after OFDM baseband generation that does not include a cyclic prefix 330 (e.g., symbol so). In some examples, for a k-th symbol 325 (e.g., symbol sₖ), the transmitting device 310 may apply a cyclic shift to the left to the preceding symbol 325 (e.g., symbol sₖ₋₁). For example, The preceding symbol 325 may be shifted to the left by the duration of the cyclic prefix 330. The cyclic shift may be defined by Equation 2 below.

$${s}_{k} ( t ) = {s}_{k - 1} ( ( t + {N}_{c p} {T}_{c} ) mod ( {T}_{s y m b o l} - {N}_{c p} {T}_{C} ) ) \qquad ( 2 )$$

$$t = 0 , … , {T}_{s y m b o l} - {N}_{c p} {T}_{C}$$

sₖ₋₁ may represent a preceding symbol to the symbol sₖ, where sₖ₋₁(0) represents a first segment 340 (e.g., a first sample) after the cyclic prefix 330 of the preceding symbol sₖ₋₁, and where sₖ(0) represents a first segment 340 after the cyclic prefix 330 of the symbol sₖ. N_{cp} may represent a quantity of segments 340 of the cyclic prefix 330, T_{c} may be the duration of a segment 340, and N_{cp}T_{c} may represent the duration of the cyclic prefix 330. T_{symbol} may represent a total time duration of a symbol 325.

In the example of FIG. 3, the transmitting device 310 may apply a cyclic shift to the first instance of the SRS 320-a to determine the second instance of the SRS 320-b in accordance with Equation 1 above. For example, the transmitting device 310 may shift the segments 340 of the first instance of the SRS 320-a to the left by the duration of the cyclic prefix 330, such that a first segment 340 (e.g., segment 0) of the first instance of the SRS 320-a becomes a final segment 340 of the second instance of the SRS 320-b and such that a second segment 340 (e.g., segment 1) of the first instance of the SRS 320-a becomes a first segment 340 of the second instance of the SRS 320-b. After applying the cyclic shift, the transmitting device 310 may add (e.g., append) the final segment 340 of the second instance of the SRS 320-b to the beginning of the second instance of the SRS 320-b as the second cyclic prefix 330-b.

By applying the cyclic shift to the second instance of the SRS 320-b, the receiving device 305 may measure the SRS 320 during an observation window 335 (e.g., an FFT duration) that contains (e.g., includes, spans) at least one full period of an instance of the SRS 320. For example, after applying the cyclic shift to the second instance of the SRS 320-b and adding the second cyclic prefix 330-b to the second symbol 325-b, the SRS 320 may be transmitted periodically across the first symbol 325-a and the second symbol 325-b with a period equal to the duration of an instance of the SRS 320. That is, the SRS 320 may maintain periodicity across multiple symbols 325 with a period equal to the duration of an instance of the SRS 320. Accordingly, the observation window 335 may include a full period of the SRS 320, regardless of the position of the observation window 335 (e.g., in time). In some examples, the full period of the SRS 320 received during the observation window 335 may be cyclically shifted relative to an original SRS 320 (e.g., the first instance of the SRS 320-a).

The receiving device 305 may receive the portion of first instance of the SRS 320-a and the portion of the second instance of the SRS 320-b during the observation window 335. Based on the cyclic shift and the second cyclic prefix 330-b, the portion of the first instance of the SRS 320-a and the portion of the second instance of the SRS 320-b may comprise the entire SRS 320 (e.g., a full period of the SRS 320). Accordingly, by measuring the portion of first instance of the SRS 320-a and the portion of the second instance of the SRS 320-b, the receiving device may measure the entire SRS 320 within the observation window 335. The receiving device 305 may report the measurements to the network entity (e.g., via a measurement report). The network entity may schedule the receiving device 305 based on the measurement report.

In some examples, the network entity may indicate information to the receiving device 305 for receiving the SRS 320. For example, the network entity may indicate configuration information for the SRS 320 (e.g., CLI-SRS configuration information) to the receiving device 305. The CLI-SRS configuration information may include the SCS of the transmitting device 310 SCS_{T}, the SCS of the receiving device 305 SCS_{R}, a comb size of the transmitting device 310 C₁, a comb size of the receiving device 305 C₂, the quantity of symbols 325 over which the transmitting device 310 transmits SRS 320 Nₜ, or any combination thereof. The CLI-SRS configuration information may be based on SCS_{R} or based on SCS_{T}. An example showing the relationship between SCS_{R}, SCS_{T}, and the CLI-SRS configuration information is depicted in Table 1 below.

TABLE 1

| Case | Transmitter Comb C₂ | Receiver Comb C₂ | N_{T} |
|---|---|---|---|
| SCS_{T} = SCS_{R} | C₁ = 2, 4, 8 | C₂ = C₁ | N_{T} ≥ 2 |
| SCS_{T} = 2SCS_{R} | C₁ = 2, 4 | C₂ = 2C₁ | N_{T} ≥ 4 |
| $S C {S}_{T} = \frac{1}{2} S C {S}_{R}$ | C₁ = 4, 8 | ${C}_{2} = \frac{1}{2} {C}_{1}$ | N_{T} ≥ 1 |

In some cases, the receiving device 305 may receive an indication of a comb size C₂ for receiving the SRS 320, may receive an indication of a quantity of symbols including the SRS 320 N_{T}, or both, determined in accordance with SCS_{R}. For example, as depicted in the example of Table 1, if the receiving device 305 and the transmitting device 310 have the same SCS (e.g., SCS_{T}=SCS_{R}), then the receiving device 305 may be configured with a comb size C₂ equal to a comb size C₁ configured for the transmitting device. In some other cases, the receiving device 305 may receive an indication of SCS_{T}, a comb size C₁ for transmitting the SRS 320 by the transmitting device 310, a quantity of symbols 325 over which the transmitting device 310 transmits SRS 320 Nₜ, or any combination thereof, determined in accordance with SCS_{T}.

Additionally, or alternatively, the network entity may indicate configuration information for the resources used to communicate the SRS 320 (e.g., SRS resource set configuration information). For example, the receiving device 305 may receive configuration information for resources (e.g., a resource set) for receiving the SRS 320. In some examples, the resource set configuration information may indicate a frequency offset for receiving the SRS 320. In some examples, the transmitting device 310 may transmit signaling in accordance with (e.g., within) an NTN PRB boundary, and the receiving device 305 may receive signaling in accordance with a TN PRB boundary. The NTN PRB boundary may be different from the TN PRB boundary. Accordingly, the resource set configuration information may indicate the frequency offset via a quantity of PRBs the receiving device 305 may adjust the TN PRB boundary by to receive the SRS 320 transmitted in accordance with the NTN PRB boundary. In some other examples, the transmitting device 310 may transmit signaling in accordance with a reference frequency (e.g., PointA) for NTN communications (e.g., associated with a non-terrestrial network entity), and the receiving device may receive signaling in accordance with a reference frequency for TN communications (e.g., associated with a terrestrial network entity). Accordingly, the resource set configuration information may indicate the frequency offset via a difference between the NTN reference frequency and the TN reference frequency.

Additionally, or alternatively, the network entity may indicate configuration information for the SRS 320 to the transmitting device 310. In some cases, the transmitting device 310 may receive an indication from the network entity to refrain from transmitting the SRS 320 with frequency pre-compensation. In some other cases, the transmitting device 310 may receive an indication from the network entity to transmit the SRS 320 with frequency pre-compensation.

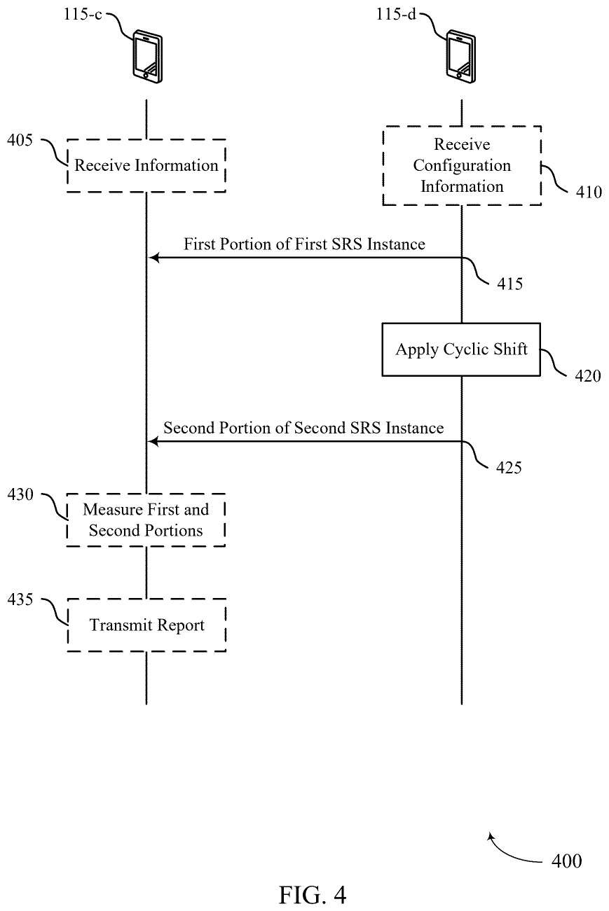

FIG. 4 shows an example of a process flow 400 that supports CLI measurement for NTN spectrum sharing in accordance with one or more aspects of the present disclosure. The process flow 400 may implement or be implemented by aspects of the wireless communications system 100, the wireless communications system 200, and the symbol pattern 300, as described with reference to FIGS. 1-3. For example, the process flow 400 illustrates actions performed by a first UE 115-c and a second UE 115-d, which may be examples of corresponding devices described herein, including with reference to FIGS. 1-3. In the following description of the process flow 400, the operations between the first UE 115-c and the second UE 115-d may be performed in a different order than the example shown, or the operations between the first UE 115-c and the second UE 115-d may be performed in different orders at different times. Some operations may also be omitted from the process flow 400, and other operations may be added to the process flow 400. In some examples, the first UE 115-c may operate in a TN and may be in communication with the second UE 115-d, which may operate in an NTN. The first UE 115-c and the second UE 115-d may also be in communication with a network entity (not shown).

At 405, the first UE 115-c may receive information from the network entity. For example, in some cases the first UE 115-c may receive configuration information associated with an SRS. In such cases, the configuration information may indicate one or more of: a comb size associated with the SRS, a quantity of symbols associated with the SRS, or both. The configuration information may be in accordance with (e.g., based on) an SCS associated with the first UE 115-c. In some other cases, the first UE 115-c may receive configuration information associated with a resource set associated with the SRS. In such cases, the configuration information may indicate a frequency offset associated with the SRS, and the UE may receive at least a first portion of a first instance of the SRS and receives at least a second portion of a second instance of the SRS in accordance with the frequency offset. The frequency offset may indicate a quantity of subcarriers with respect to a PRB boundary of the first UE 115-c or may indicate a difference between a first reference frequency associated with a first network entity (e.g., associated with the TN) and a second reference frequency associated with a second network entity (e.g., associated with the NTN).

In some other examples, the first UE 115-c may receive information associated with the second UE 115-d. For example, the information may include one or more of: an SCS associated with the second UE 115-d, a comb size associated with the second UE 115-d, a quantity of symbols associated with the SRS, or any combination thereof. In such examples, the comb size and the quantity of symbols may be in accordance with (e.g., based on) the SCS associated with the second UE 115-d.

At 410, the second UE 115-d may receive configuration information associated with the SRS from the network entity. In some examples, the configuration information received by the second UE 115-d may indicate whether the second UE 115-d applies or refrains from applying frequency precompensation to signaling (e.g., SRSs) transmitted by the second UE 115-d.

At 415, the first UE 115-c may receive at least the first portion of the first instance of the SRS in a first symbol. The first symbol may include a first cyclic prefix. In some examples, the second UE 115-d may transmit the first instance of the SRS. In such examples, the second UE 115-d may refrain from applying a frequency precompensation to the first instance of the SRS in accordance with the configuration information received from the network entity.

At 420, the second UE 115-d may apply a cyclic shift to the first instance of the SRS. The cyclic shift may be based on a duration of the first cyclic prefix. In some examples, the second UE 115-d may apply the cyclic shift to the first instance of the SRS to determine a second instance of the SRS. For example, the cyclic shift for a symbol sₖ may be defined by the following expression: sₖ₋₁((t+N_{cp}T_{c}) mod (T_{symbol}−N_{cp}T_{c})) for ranges of t between 0 and T_{symbol}−N_{cp}T_{c}. In such examples, sₖ₋₁ may be a preceding symbol, where sₖ₋₁(0) is a first sample after the cyclic prefix of the preceding symbol sₖ₋₁ and sₖ(0) is a first sample after the cyclic prefix of a symbol sₖ, N_{cp} may be a quantity of samples of the first cyclic prefix, T_{c} may be a duration of a sample, and N_{cp}T_{c} may be a duration of the first cyclic prefix, and T_{symbol} may be a total time duration of the first symbol

At 425, the first UE 115-c may receive at least the second portion of the second instance of the SRS in a second symbol that includes the second cyclic prefix and is consecutive to the first symbol in time. The second instance of the SRS may be based on the cyclic shift applied to the first instance of the SRS. In some examples, a combination of the first portion of the first instance of the SRS and the second portion of the second instance of the SRS may comprise a full period of the SRS. In such examples, the SRS may have a duration of T_{symbol}−N_{cp}T_{c}, where T_{symbol} is the total time duration of the first symbol, N_{cp} is the quantity of samples of the first cyclic prefix, T_{c} is the duration of a sample, and N_{cp}T_{c} is the duration of the first cyclic prefix.

At 430, the first UE 115-c may measure both the first portion of the first instance of the SRS and the second portion of the second instance of the SRS during a measurement window. In some examples, the first UE 115-c may receive both the first portion of the first instance of the SRS signal and the second portion of the second instance of the SRS during the measurement window. For example, the measurement window may span at least a portion of the first symbol that includes the first portion of the first instance of the SRS and at least a portion of the second symbol that includes the second portion of the second instance of the SRS. In some examples, the measurement window may be expressed in symbols associated with the first UE 115-a and may be based on one or more parameters Nₜ, SCS_{R}, SCS_{T}, or any combination thereof. For example, the measurement window may be defined by the following expression: Nₜ*(SCS_{R}/SCS_{T})+(0, 2); where Nₜ may be a quantity of symbols associated with the SRS, SCS_{R} may be an SCS associated with the first UE 115-c, and SCS_{T} may be an SCS associated with the second UE 115-d.

At 435, the first UE 115-c may transmit a report indicating interference information associated with the SRS. The interference information may be in accordance with the measuring (e.g., determined based on the measuring). In some examples, the first UE 115-c may transmit the report to the network entity. In such examples, the network entity may schedule the first UE 115-c based on the interference information.

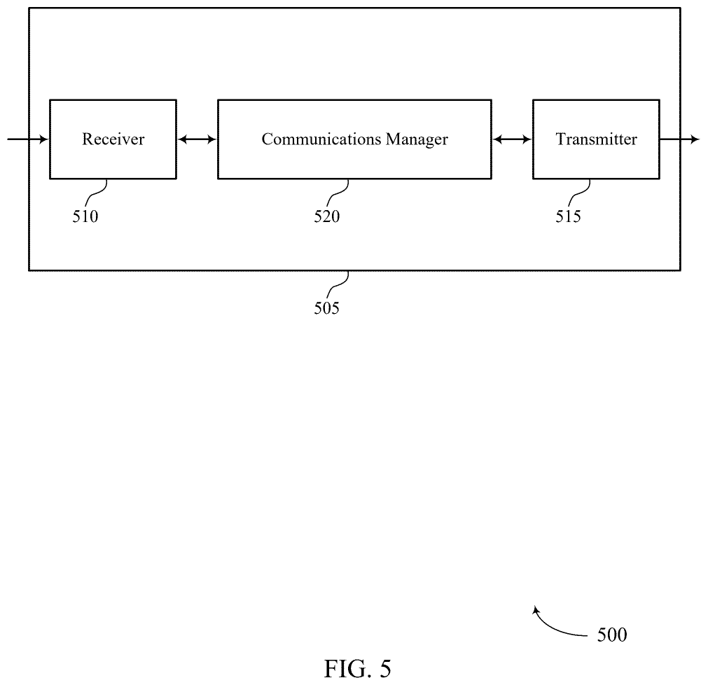

FIG. 5 shows a block diagram 500 of a device 505 that supports CLI measurement for NTN spectrum sharing in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to CLI measurement for NTN spectrum sharing). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to CLI measurement for NTN spectrum sharing). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of CLI measurement for NTN spectrum sharing as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving at least a first portion of a first instance of an SRS in a first symbol, where the first symbol includes a first cyclic prefix. The communications manager 520 is capable of, configured to, or operable to support a means for receiving at least a second portion of a second instance of the sounding reference signal in a second symbol that includes a second cyclic prefix and is consecutive to the first symbol in time, where the second instance of the sounding reference signal is based on a cyclic shift applied to the first instance of the sounding reference signal, the cyclic shift being based on a duration of the first cyclic prefix.

Additionally, or alternatively, the communications manager 520 may support wireless communications in accordance with examples as disclosed herein. For example, the communications manager 520 is capable of, configured to, or operable to support a means for transmitting a first instance of an SRS in a first symbol, where the first symbol includes a first cyclic prefix. The communications manager 520 is capable of, configured to, or operable to support a means for applying a cyclic shift to the first instance of the sounding reference signal, where the cyclic shift is based on a duration of the first cyclic prefix. The communications manager 520 is capable of, configured to, or operable to support a means for transmitting a second instance of the sounding reference signal in a second symbol in accordance with the cyclic shift, where the second symbol includes a second cyclic prefix, and where the first symbol and the second symbol are consecutive in time.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for more efficient utilization of communication resources.

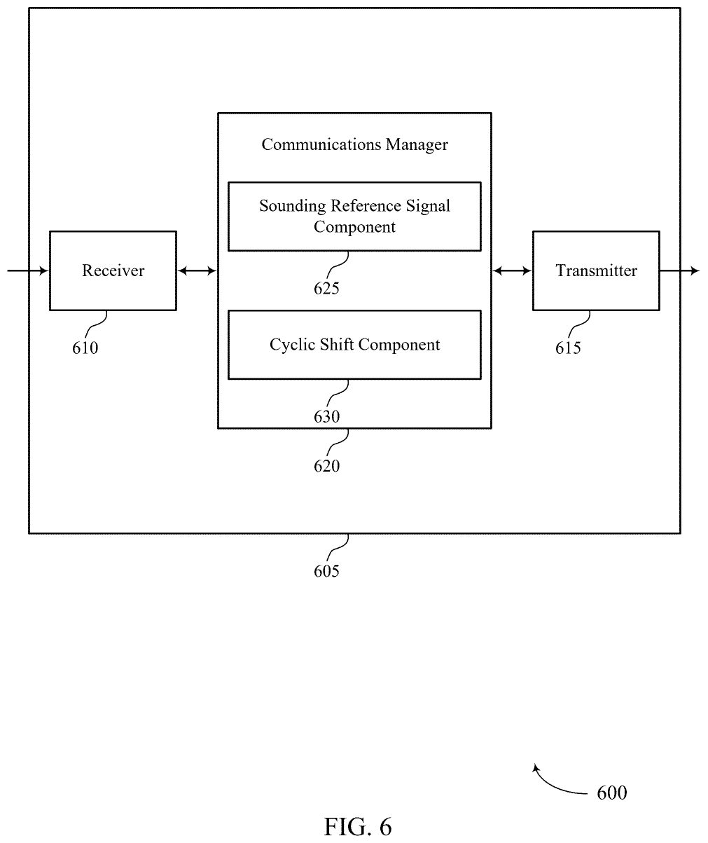

FIG. 6 shows a block diagram 600 of a device 605 that supports CLI measurement for NTN spectrum sharing in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to CLI measurement for NTN spectrum sharing). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to CLI measurement for NTN spectrum sharing). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of CLI measurement for NTN spectrum sharing as described herein. For example, the communications manager 620 may include an SRS component 625 a cyclic shift component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The sounding reference signal component 625 is capable of, configured to, or operable to support a means for receiving at least a first portion of a first instance of an SRS in a first symbol, where the first symbol includes a first cyclic prefix. The sounding reference signal component 625 is capable of, configured to, or operable to support a means for receiving at least a second portion of a second instance of the sounding reference signal in a second symbol that includes a second cyclic prefix and is consecutive to the first symbol in time, where the second instance of the sounding reference signal is based on a cyclic shift applied to the first instance of the sounding reference signal, the cyclic shift being based on a duration of the first cyclic prefix.

Additionally, or alternatively, the communications manager 620 may support wireless communications in accordance with examples as disclosed herein. The sounding reference signal component 625 is capable of, configured to, or operable to support a means for transmitting a first instance of an SRS in a first symbol, where the first symbol includes a first cyclic prefix. The cyclic shift component 630 is capable of, configured to, or operable to support a means for applying a cyclic shift to the first instance of the sounding reference signal, where the cyclic shift is based on a duration of the first cyclic prefix. The sounding reference signal component 625 is capable of, configured to, or operable to support a means for transmitting a second instance of the sounding reference signal in a second symbol in accordance with the cyclic shift, where the second symbol includes a second cyclic prefix, and where the first symbol and the second symbol are consecutive in time.

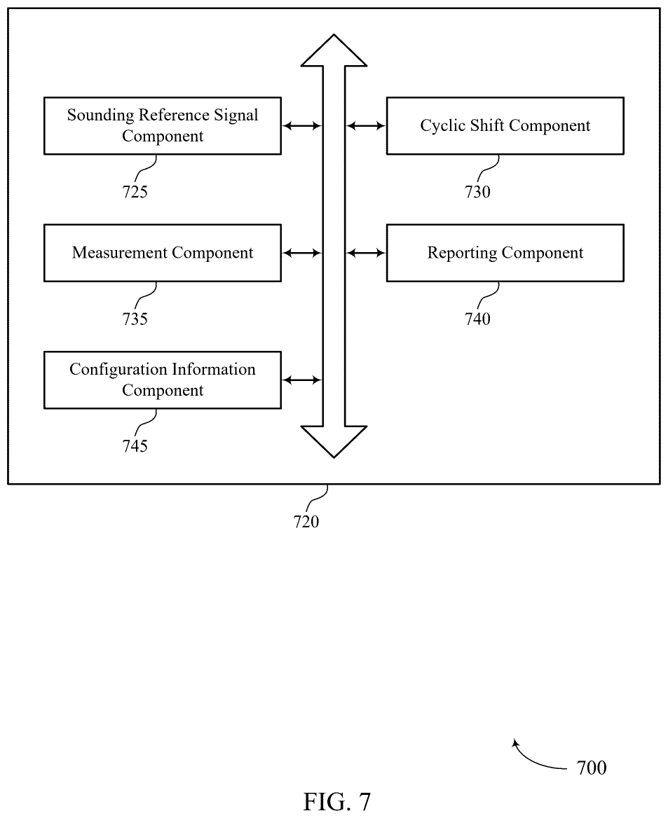

FIG. 7 shows a block diagram 700 of a communications manager 720 that supports CLI measurement for NTN spectrum sharing in accordance with one or more aspects of the present disclosure. The communications manager 720 may be an example of aspects of a communications manager 520, a communications manager 620, or both, as described herein. The communications manager 720, or various components thereof, may be an example of means for performing various aspects of CLI measurement for NTN spectrum sharing as described herein. For example, the communications manager 720 may include an SRS component 725, a cyclic shift component 730, a measurement component 735, a reporting component 740, a configuration information component 745, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The sounding reference signal component 725 is capable of, configured to, or operable to support a means for receiving at least a first portion of a first instance of an SRS in a first symbol, where the first symbol includes a first cyclic prefix. In some examples, the sounding reference signal component 725 is capable of, configured to, or operable to support a means for receiving at least a second portion of a second instance of the sounding reference signal in a second symbol that includes a second cyclic prefix and is consecutive to the first symbol in time, where the second instance of the sounding reference signal is based on a cyclic shift applied to the first instance of the sounding reference signal, the cyclic shift being based on a duration of the first cyclic prefix.

In some examples, the measurement component 735 is capable of, configured to, or operable to support a means for measuring both the first portion of the first instance of the sounding reference signal and the second portion of the second instance of the sounding reference signal during a measurement window, where the measurement window spans at least a portion of the first symbol and at least a portion of the second symbol. In some examples, the reporting component 740 is capable of, configured to, or operable to support a means for transmitting a report indicating interference information associated with the sounding reference signal, where the interference information is in accordance with the measuring.

In some examples, the configuration information component 745 is capable of, configured to, or operable to support a means for receiving configuration information associated with the sounding reference signal, where the configuration information indicates one or more of: a comb size associated with the sounding reference signal, a quantity of symbols associated with the sounding reference signal, or both, and where the configuration information is in accordance with an SCS associated with the UE.

In some examples, the configuration information component 745 is capable of, configured to, or operable to support a means for receiving information associated with a second UE, the information including one or more of: an SCS associated with the second UE, a comb size associated with the second UE, a quantity of symbols associated with the sounding reference signal, or any combination thereof, where the comb size and the quantity of symbols are in accordance with the SCS associated with the second UE.

In some examples, the configuration information component 745 is capable of, configured to, or operable to support a means for receiving configuration information associated with a resource set associated with the sounding reference signal, the configuration information indicating a frequency offset associated with the sounding reference signal, where the UE receives at least the first portion of the first instance of the sounding reference signal and receives at least the second portion of the second instance of the sounding reference signal in accordance with the frequency offset.

In some examples, the frequency offset indicates a quantity of subcarriers with respect to a physical resource block boundary of the UE.

In some examples, the frequency offset indicates a difference between a first reference frequency associated with a first network entity and a second reference frequency associated with a second network entity.

In some examples, to support receiving at least the first portion of the first instance of the sounding reference signal and receiving at least the second portion of the second instance of the sounding reference signal, the sounding reference signal component 725 is capable of, configured to, or operable to support a means for receiving both the first portion of the first instance of the sounding reference signal and the second portion of the second instance of the sounding reference signal during a measurement window, wherein the measurement window is expressed in symbols associated with the UE and is based at least in part on one or more parameters Nₜ, SCS_{R}, SCS_{T}, or any combination thereof; where Nₜ is a quantity of symbols associated with the SRS; where SCS_{R} is an SCS associated with the UE; and where SCS_{T} is an SCS associated with a second UE.

In some examples, a symbol sₖ excluding the cyclic prefix is defined by: sₖ₋₁((t+N_{cp}T_{c}) mod (T_{symbol}−N_{cp}T_{c})) for ranges of t between 0 and T_{symbol}−N_{cp}T_{c}; where sₖ₋₁ is a preceding symbol, where sₖ₋₁(0) is a first sample after the cyclic prefix of the preceding symbol sₖ₋₁ and sₖ(0) is a first sample after the cyclic prefix of a symbol sₖ; where N_{cp} is a quantity of samples of the first cyclic prefix, T_{c} is a duration of a sample, and N_{cp}T_{c} is a duration of the first cyclic prefix; and where T_{symbol} is a total time duration of the first symbol.

In some examples, a combination of the first portion of the first instance of the sounding reference signal and the second portion of the second instance of the sounding reference signal comprise a full period of the sounding reference signal, the sounding reference signal having a duration of T_{symbol}−N_{cp}T_{c}; where T_{symbol} is a total time duration of the first symbol, N_{cp} is a quantity of samples of the first cyclic prefix, T_{c} is a duration of a sample, and N_{cp}T_{c} is a duration of the first cyclic prefix.

In some examples, the UE operates in a terrestrial network and is in communication with a second UE that operates in an NTN.

Additionally, or alternatively, the communications manager 720 may support wireless communications in accordance with examples as disclosed herein. In some examples, the sounding reference signal component 725 is capable of, configured to, or operable to support a means for transmitting a first instance of an SRS in a first symbol, where the first symbol includes a first cyclic prefix. The cyclic shift component 730 is capable of, configured to, or operable to support a means for applying a cyclic shift to the first instance of the sounding reference signal, where the cyclic shift is based on a duration of the first cyclic prefix. In some examples, the sounding reference signal component 725 is capable of, configured to, or operable to support a means for transmitting a second instance of the sounding reference signal in a second symbol in accordance with the cyclic shift, where the second symbol includes a second cyclic prefix, and where the first symbol and the second symbol are consecutive in time.

In some examples, the configuration information component 745 is capable of, configured to, or operable to support a means for receiving configuration information associated with the sounding reference signal. In some examples, the sounding reference signal component 725 is capable of, configured to, or operable to support a means for transmitting the first instance of the sounding reference signal, the second instance of the sounding reference signal, or both, where the UE refrains from applying a frequency precompensation to the first instance of the sounding reference signal, the second instance of the sounding reference signal, or both in accordance with the configuration information.

In some examples, a symbol sₖ excluding the cyclic prefix is defined by: sₖ₋₁((t+N_{cp}T_{c}) mod (T_{symbol}−N_{cp}T_{c})) for ranges of t between 0 and T_{symbol}−N_{cp}T_{c}; where sₖ₋₁ is a preceding symbol, where sₖ₋₁(0) is a first sample after the cyclic prefix of the preceding symbol sₖ₋₁ and sₖ(0) is a first sample after the cyclic prefix of a symbol sₖ; where N_{cp} is a quantity of samples of the first cyclic prefix, T_{c} is a duration of a sample, and N_{cp}T_{c} is a duration of the first cyclic prefix; and where T_{symbol} is a total time duration of the first symbol.

In some examples, the UE operates in an NTN and is in communication with a second UE that operates in a terrestrial network.

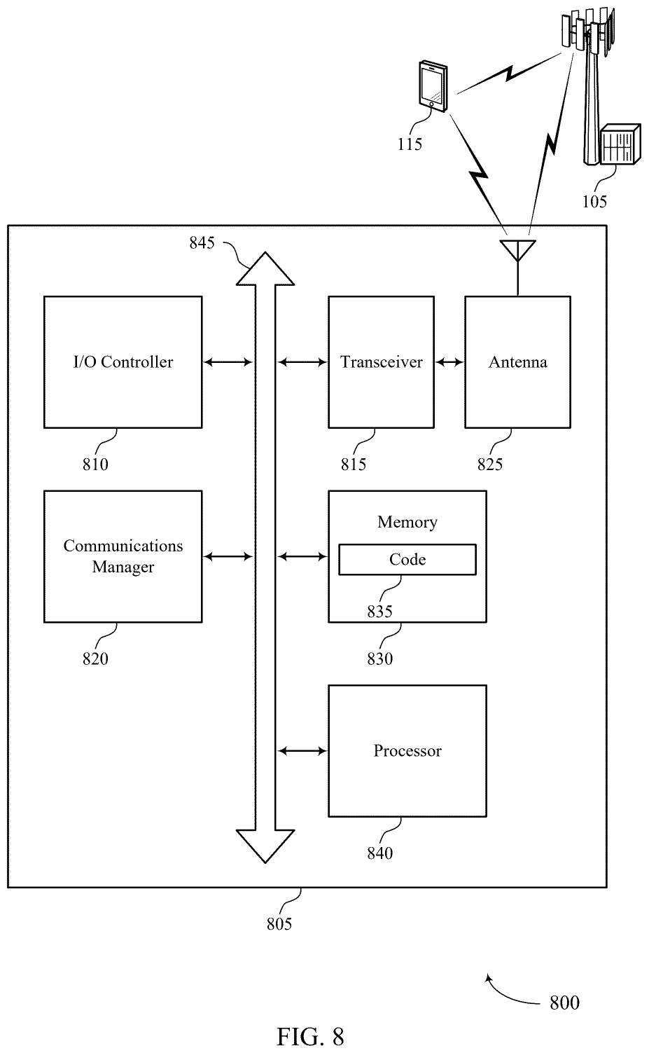

FIG. 8 shows a diagram of a system 800 including a device 805 that supports CLI measurement for NTN spectrum sharing in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting CLI measurement for NTN spectrum sharing). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving at least a first portion of a first instance of an SRS in a first symbol, where the first symbol includes a first cyclic prefix. The communications manager 820 is capable of, configured to, or operable to support a means for receiving at least a second portion of a second instance of the sounding reference signal in a second symbol that includes a second cyclic prefix and is consecutive to the first symbol in time, where the second instance of the sounding reference signal is based on a cyclic shift applied to the first instance of the sounding reference signal, the cyclic shift being based on a duration of the first cyclic prefix.

Additionally, or alternatively, the communications manager 820 may support wireless communications in accordance with examples as disclosed herein. For example, the communications manager 820 is capable of, configured to, or operable to support a means for transmitting a first instance of an SRS in a first symbol, where the first symbol includes a first cyclic prefix. The communications manager 820 is capable of, configured to, or operable to support a means for applying a cyclic shift to the first instance of the sounding reference signal, where the cyclic shift is based on a duration of the first cyclic prefix. The communications manager 820 is capable of, configured to, or operable to support a means for transmitting a second instance of the sounding reference signal in a second symbol in accordance with the cyclic shift, where the second symbol includes a second cyclic prefix, and where the first symbol and the second symbol are consecutive in time.

By including or configuring the communications manager 820 in accordance with examples as described herein, the device 805 may support techniques for improved communication reliability and improved user experience related to more efficient utilization of communication resources and improved coordination between devices.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of CLI measurement for NTN spectrum sharing as described herein, or the at least one processor 840 and the at least one memory 830 may be otherwise configured to, individually or collectively, perform or support such operations.

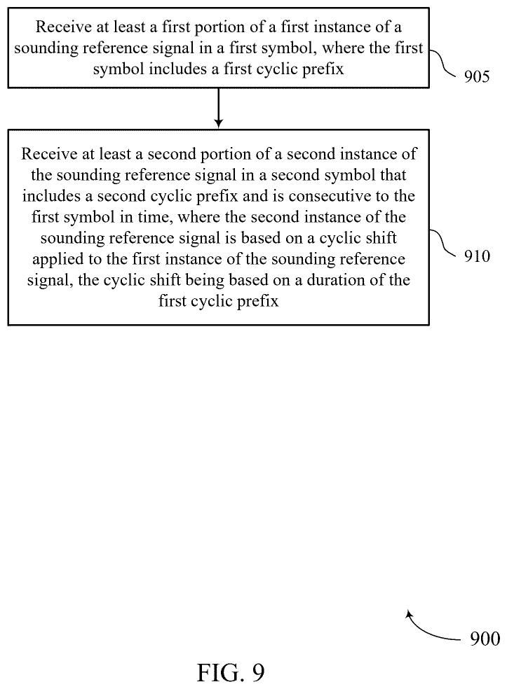

FIG. 9 shows a flowchart illustrating a method 900 that supports CLI measurement for NTN spectrum sharing in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving at least a first portion of a first instance of an SRS in a first symbol, where the first symbol includes a first cyclic prefix. The operations of 905 may be performed in accordance with examples as disclosed herein. In some examples, aspects of the operations of 905 may be performed by an SRS component 725 as described with reference to FIG. 7.

At 910, the method may include receiving at least a second portion of a second instance of the sounding reference signal in a second symbol that includes a second cyclic prefix and is consecutive to the first symbol in time, where the second instance of the sounding reference signal is based on a cyclic shift applied to the first instance of the sounding reference signal, the cyclic shift being based on a duration of the first cyclic prefix. The operations of 910 may be performed in accordance with examples as disclosed herein. In some examples, aspects of the operations of 910 may be performed by an SRS component 725 as described with reference to FIG. 7.

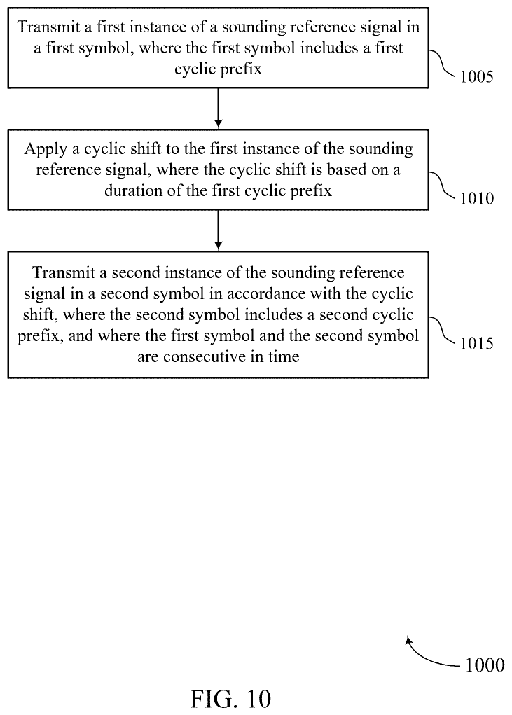

FIG. 10 shows a flowchart illustrating a method 1000 that supports CLI measurement for NTN spectrum sharing in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include transmitting a first instance of an SRS in a first symbol, where the first symbol includes a first cyclic prefix. The operations of 1005 may be performed in accordance with examples as disclosed herein. In some examples, aspects of the operations of 1005 may be performed by an SRS component 725 as described with reference to FIG. 7.

At 1010, the method may include applying a cyclic shift to the first instance of the sounding reference signal, where the cyclic shift is based on a duration of the first cyclic prefix. The operations of 1010 may be performed in accordance with examples as disclosed herein. In some examples, aspects of the operations of 1010 may be performed by a cyclic shift component 730 as described with reference to FIG. 7.

At 1015, the method may include transmitting a second instance of the sounding reference signal in a second symbol in accordance with the cyclic shift, where the second symbol includes a second cyclic prefix, and where the first symbol and the second symbol are consecutive in time. The operations of 1015 may be performed in accordance with examples as disclosed herein. In some examples, aspects of the operations of 1015 may be performed by an SRS component 725 as described with reference to FIG. 7.

The following provides an overview of aspects of the present disclosure:

Aspect 1: A method for wireless communications at a UE, comprising: receiving at least a first portion of a first instance of a SRS in a first symbol, wherein the first symbol includes a first cyclic prefix; and receiving at least a second portion of a second instance of the SRS in a second symbol that includes a second cyclic prefix and is consecutive to the first symbol in time, wherein the second instance of the SRS is based at least in part on a cyclic shift applied to the first instance of the SRS, the cyclic shift being based at least in part on a duration of the first cyclic prefix.

Aspect 2: The method of aspect 1, further comprising: measuring both the first portion of the first instance of the SRS and the second portion of the second instance of the SRS during a measurement window, wherein the measurement window spans at least a portion of the first symbol and at least a portion of the second symbol; and transmitting a report indicating interference information associated with the SRS, wherein the interference information is in accordance with the measuring.

Aspect 3: The method of any of aspects 1 through 2, further comprising: receiving configuration information associated with the SRS, wherein the configuration information indicates one or more of: a comb size associated with the SRS, a quantity of symbols associated with the SRS, or both, and wherein the configuration information is in accordance with a SCS associated with the UE.

Aspect 4: The method of any of aspects 1 through 3, further comprising: receiving information associated with a second UE, the information comprising one or more of: a SCS associated with the second UE, a comb size associated with the second UE, a quantity of symbols associated with the SRS, or any combination thereof, wherein the comb size and the quantity of symbols are in accordance with the SCS associated with the second UE.

Aspect 5: The method of any of aspects 1 through 4, further comprising: receiving configuration information associated with a resource set associated with the SRS, the configuration information indicating a frequency offset associated with the SRS, wherein the UE receives at least the first portion of the first instance of the SRS and receives at least the second portion of the second instance of the SRS in accordance with the frequency offset.

Aspect 6: The method of aspect 5, wherein the frequency offset indicates a quantity of subcarriers with respect to a PRB boundary of the UE.

Aspect 7: The method of any of aspects 5 through 6, wherein the frequency offset indicates a difference between a first reference frequency associated with a first network entity and a second reference frequency associated with a second network entity.

Aspect 8: The method of any of aspects 1 through 7, wherein receiving at least the first portion of the first instance of the SRS and receiving at least the second portion of the second instance of the SRS further comprises: receiving both the first portion of the first instance of the SRS and the second portion of the second instance of the SRS during a measurement window, wherein the measurement window is expressed in symbols associated with the UE and is based at least in part on one or more parameters Nₜ, SCS_{R}, SCS_{T}, or any combination thereof, where Nₜ is a quantity of symbols associated with the SRS, where SCS_{R} is a SCS associated with the UE, and where SCS_{T} is a SCS associated with a second UE.

Aspect 9: The method of any of aspects 1 through 8, wherein the cyclic shift for a symbol sₖ is defined by sₖ₋₁((t+N_{cp}T_{c}) mod (T_{symbol}−N_{cp}T_{c})) for ranges of t between 0 and T_{symbol}−N_{cp}T_{c}; where sₖ₋₁ is a preceding symbol, where sₖ₋₁(0) is a first sample after the cyclic prefix of the preceding symbol sₖ₋₁ and sₖ(0) is a first sample after the cyclic prefix of a symbol sₖ; where N_{cp} is a quantity of samples of the first cyclic prefix, T_{c} is a duration of a sample, and N_{cp}T_{c} is a duration of the first cyclic prefix; and where T_{symbol} is a total time duration of the first symbol.

Aspect 10: The method of any of aspects 1 through 9, wherein a combination of the first portion of the first instance of the SRS and the second portion of the second instance of the SRS comprise a full period of the SRS, the SRS having a duration of T_{symbol}−N_{cp}T_{c}; where T_{symbol} is a total time duration of the first symbol, N_{cp} is a quantity of samples of the first cyclic prefix, T_{c} is a duration of a sample, and N_{cp}T_{c} is a duration of the first cyclic prefix.

Aspect 11: The method of any of aspects 1 through 10, wherein the UE operates in a TN and is in communication with a second UE that operates in an NTN.

Aspect 12: A method for wireless communications at a UE, comprising: transmitting a first instance of a SRS in a first symbol, wherein the first symbol includes a first cyclic prefix; applying a cyclic shift to the first instance of the SRS, wherein the cyclic shift is based at least in part on a duration of the first cyclic prefix; and transmitting a second instance of the SRS in a second symbol in accordance with the cyclic shift, wherein the second symbol includes a second cyclic prefix, and wherein the first symbol and the second symbol are consecutive in time.

Aspect 13: The method of aspect 12, further comprising: receiving configuration information associated with the SRS; and transmitting the first instance of the SRS, the second instance of the SRS, or both, wherein the UE refrains from applying a frequency precompensation to the first instance of the SRS, the second instance of the SRS, or both in accordance with the configuration information.

Aspect 14: The method of any of aspects 12 through 13, wherein a symbol sₖ excluding the cyclic prefix is defined by sₖ₋₁((t+N_{cp}T_{c}) mod (T_{symbol}−N_{cp}T_{c})) for ranges of t between 0 and T_{symbol}−N_{cp}T_{c}; where sₖ₋₁ is a preceding symbol, where sₖ₋₁(0) is a first sample after the cyclic prefix of the preceding symbol sₖ₋₁ and sₖ(0) is a first sample after the cyclic prefix of a symbol sₖ; where N_{cp} is a quantity of samples of the first cyclic prefix, T_{c} is a duration of a sample, and N_{cp}T_{c} is a duration of the first cyclic prefix; and where T_{symbol} is a total time duration of the first symbol.

Aspect 15: The method of any of aspects 12 through 14, wherein the UE operates in an NTN and is in communication with a second UE that operates in a TN.

Aspect 16: A UE for wireless communications, comprising one or more memories storing processor-executable code, and one or more processors coupled with the one or more memories and individually or collectively operable to execute the code to cause the UE to perform a method of any of aspects 1 through 11.

Aspect 17: A UE for wireless communications, comprising at least one means for performing a method of any of aspects 1 through 11.

Aspect 18: A non-transitory computer-readable medium storing code for wireless communications, the code comprising instructions executable by one or more processors to perform a method of any of aspects 1 through 11.

Aspect 19: A UE for wireless communications, comprising one or more memories storing processor-executable code, and one or more processors coupled with the one or more memories and individually or collectively operable to execute the code to cause the UE to perform a method of any of aspects 12 through 15.

Aspect 20: A UE for wireless communications, comprising at least one means for performing a method of any of aspects 12 through 15.

Aspect 21: A non-transitory computer-readable medium storing code for wireless communications, the code comprising instructions executable by one or more processors to perform a method of any of aspects 12 through 15.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive at least a first portion of a first instance of a sounding reference signal in a first symbol, wherein the first symbol includes a first cyclic prefix; and
receive at least a second portion of a second instance of the sounding reference signal in a second symbol that includes a second cyclic prefix and is consecutive to the first symbol in time, wherein the second instance of the sounding reference signal is based at least in part on a cyclic shift applied to the first instance of the sounding reference signal, the cyclic shift being based at least in part on a duration of the first cyclic prefix.

2. The UE of claim 1, wherein the one or more processors are individually or collectively further operable to execute the code to cause the UE to:
measure both the first portion of the first instance of the sounding reference signal and the second portion of the second instance of the sounding reference signal during a measurement window, wherein the measurement window spans at least a portion of the first symbol and at least a portion of the second symbol; and
transmit a report indicating interference information associated with the sounding reference signal, wherein the interference information is in accordance with the measuring.

3. The UE of claim 1, wherein the one or more processors are individually or collectively further operable to execute the code to cause the UE to:
receive configuration information associated with the sounding reference signal, wherein the configuration information indicates one or more of: a comb size associated with the sounding reference signal, a quantity of symbols associated with the sounding reference signal, or both, and wherein the configuration information is in accordance with a subcarrier spacing associated with the UE.

4. The UE of claim 1, wherein the one or more processors are individually or collectively further operable to execute the code to cause the UE to:
receive information associated with a second UE, the information comprising one or more of: a subcarrier spacing associated with the second UE, a comb size associated with the second UE, a quantity of symbols associated with the sounding reference signal, or any combination thereof, wherein the comb size and the quantity of symbols are in accordance with the subcarrier spacing associated with the second UE.

5. The UE of claim 1, wherein the one or more processors are individually or collectively further operable to execute the code to cause the UE to:
receive configuration information associated with a resource set associated with the sounding reference signal, the configuration information indicating a frequency offset associated with the sounding reference signal, wherein the UE receives at least the first portion of the first instance of the sounding reference signal and receives at least the second portion of the second instance of the sounding reference signal in accordance with the frequency offset.

6. The UE of claim 5, wherein the frequency offset indicates a quantity of subcarriers with respect to a physical resource block boundary of the UE.

7. The UE of claim 5, wherein the frequency offset indicates a difference between a first reference frequency associated with a first network entity and a second reference frequency associated with a second network entity.

8. The UE of claim 1, wherein, to receive at least the first portion of the first instance of the sounding reference signal and receiving at least the second portion of the second instance of the sounding reference signal, the one or more processors are individually or collectively further operable to execute the code to cause the UE to:
receive both the first portion of the first instance of the sounding reference signal and the second portion of the second instance of the sounding reference signal during a measurement window, wherein the measurement window is expressed in symbols associated with the UE and is based at least in part on one or more parameters Nₜ, SCS_{R}, SCS_{T}, or any combination thereof;
where Nₜ is a quantity of symbols associated with the sounding reference signal;
where SCS_{R} is a subcarrier spacing associated with the UE; and
where SCS_{T} is a subcarrier spacing associated with a second UE.

9. The UE of claim 1, wherein the cyclic shift for a symbol sₖ is defined by:
sₖ₋₁((t+N_{cp}T_{c}) mod (T_{symbol}−N_{cp}T_{c})) for ranges of t between 0 and T_{symbol}−N_{cp}T_{c};
where sₖ₋₁ is a preceding symbol, where sₖ₋₁(0) is a first sample after the cyclic prefix of the preceding symbol sₖ₋₁ and sₖ(0) is a first sample after the cyclic prefix of a symbol sₖ;
where N_{cp} is a quantity of samples of the first cyclic prefix, T_{c} is a duration of a sample, and N_{cp}T_{c} is a duration of the first cyclic prefix; and
where T_{symbol} is a total time duration of the first symbol.

10. The UE of claim 1, wherein a combination of the first portion of the first instance of the sounding reference signal and the second portion of the second instance of the sounding reference signal comprise a full period of the sounding reference signal, the sounding reference signal having a duration of T_{symbol}−N_{cp}T_{c};
where T_{symbol} is a total time duration of the first symbol, N_{cp} is a quantity of samples of the first cyclic prefix, T_{c} is a duration of a sample, and N_{cp}T_{c} is a duration of the first cyclic prefix.

11. The UE of claim 1, wherein the UE operates in a terrestrial network and is in communication with a second UE that operates in a non-terrestrial network.

12. A user equipment (UE), comprising:
one or more memories storing processor-executable code; and
one or more processors coupled with the one or more memories and individually or collectively operable to execute the code to cause the UE to:
transmit a first instance of a sounding reference signal in a first symbol, wherein the first symbol includes a first cyclic prefix;
apply a cyclic shift to the first instance of the sounding reference signal, wherein the cyclic shift is based at least in part on a duration of the first cyclic prefix; and
transmit a second instance of the sounding reference signal in a second symbol in accordance with the cyclic shift, wherein the second symbol includes a second cyclic prefix, and wherein the first symbol and the second symbol are consecutive in time.

13. The UE of claim 12, wherein the one or more processors are individually or collectively further operable to execute the code to cause the UE to:
receive configuration information associated with the sounding reference signal; and
transmit the first instance of the sounding reference signal, the second instance of the sounding reference signal, or both, wherein the UE refrains from applying a frequency precompensation to the first instance of the sounding reference signal, the second instance of the sounding reference signal, or both in accordance with the configuration information.

14. The UE of claim 12, wherein a symbol sₖ excluding the cyclic prefix is defined by:
sₖ₋₁((t+N_{cp}T_{c}) mod (T_{symbol}−N_{cp}T_{c})) for ranges of t between 0 and T_{symbol}−N_{cp}T_{c};
where sₖ₋₁ is a preceding symbol, where sₖ₋₁(0) is a first sample after the cyclic prefix of the preceding symbol sₖ₋₁ and sₖ(0) is a first sample after the cyclic prefix of a symbol sₖ;
where N_{cp} is a quantity of samples of the first cyclic prefix, T_{c} is a duration of a sample, and N_{cp}T_{c} is a duration of the first cyclic prefix; and
where T_{symbol} is a total time duration of the first symbol.

15. The UE of claim 12, wherein the UE operates in a non-terrestrial network and is in communication with a second UE that operates in a terrestrial network.

16. A method for wireless communications at a user equipment (UE), comprising:
receiving at least a first portion of a first instance of a sounding reference signal in a first symbol, wherein the first symbol includes a first cyclic prefix; and
receiving at least a second portion of a second instance of the sounding reference signal in a second symbol that includes a second cyclic prefix and is consecutive to the first symbol in time, wherein the second instance of the sounding reference signal is based at least in part on a cyclic shift applied to the first instance of the sounding reference signal, the cyclic shift being based at least in part on a duration of the first cyclic prefix.

17. The method of claim 16, further comprising:
measuring both the first portion of the first instance of the sounding reference signal and the second portion of the second instance of the sounding reference signal during a measurement window, wherein the measurement window spans at least a portion of the first symbol and at least a portion of the second symbol; and
transmitting a report indicating interference information associated with the sounding reference signal, wherein the interference information is in accordance with the measuring.

18. The method of claim 16, wherein receiving at least the first portion of the first instance of the sounding reference signal and receiving at least the second portion of the second instance of the sounding reference signal further comprises:
receiving both the first portion of the first instance of the sounding reference signal and the second portion of the second instance of the sounding reference signal during a measurement window, wherein the measurement window is expressed in symbols associated with the UE and is based at least in part on one or more parameters Nₜ, SCS_{R}, SCS_{T}, or any combination thereof;
where Nₜ is a quantity of symbols associated with the sounding reference signal;
where SCS_{R} is a subcarrier spacing associated with the UE; and
where SCS_{T} is a subcarrier spacing associated with a second UE.

19. The method of claim 16, wherein a symbol sₖ excluding the cyclic prefix is defined by:
sₖ₋₁((t+N_{cp}T_{c}) mod (T_{symbol}−N_{cp}T_{c})) for ranges of t between 0 and T_{symbol}−N_{cp}T_{c};
where sₖ₋₁ is a preceding symbol, where sₖ₋₁(0) is a first sample after the cyclic prefix of the preceding symbol sₖ₋₁ and sₖ(0) is a first sample after the cyclic prefix of a symbol sₖ;
where N_{cp} is a quantity of samples of the first cyclic prefix, T_{c} is a duration of a sample, and N_{cp}T_{c} is a duration of the first cyclic prefix; and
where T_{symbol} is a total time duration of the first symbol.

20. The method of claim 16, wherein a combination of the first portion of the first instance of the sounding reference signal and the second portion of the second instance of the sounding reference signal comprise a full period of the sounding reference signal, the sounding reference signal having a duration of T symbol-N_{cp}T_{c};
where T_{symbol} is a total time duration of the first symbol, N_{cp} is a quantity of samples of the first cyclic prefix, T_{c} is a duration of a sample, and N_{cp}T_{c} is a duration of the first cyclic prefix.
